(19) United States
(12) Patent Application Publication
(10) Pub. No.: US 2019/0151991 A1
(43) Pub. Date: May 23, 2019

(54) Heating Device

(71) Applicant: KAWASAKI JUKOGYO KABUSHIKI KAISHA, Kobe-shi (JP)

(72) Inventors: Osami OOGUSHI, Kobe-shi (JP); Tadaoki YABUUCHI, Kobe-shi (JP); Kosuke KAITA, Kobe-shi (JP); Hideyuki TANAKA, Kobe-shi (JP)

(21) Appl. No.: 16/091,638

(22) PCT Filed: Apr. 6, 2017
(86) PCT No.: PCT/JP2017/014307

§ 371 Date: Oct. 5, 2018

(30) Foreign Application Priority Data
Apr. 7, 2016 (JP) 2016-077066

(51) Int. Cl. B23K 26/354; C03B 29/08; B23K 26/402

(52) U.S. Cl. CPC B23K 26/354; C03C 23/0025; B23K 26/402; C03B 29/08

(57) ABSTRACT

A heating device (90) partially heats a glass substrate (1) to be chamfered along with relative movement of the glass substrate (1). The heating device (90) is provided with a main heating part (10) and a peripheral heating part (20). The main heating part (10) heats the glass substrate (1) to a temperature near a softening point of glass. The peripheral heating part (20) heats the glass substrate (1) to a temperature lower than or equal to a strain point of glass. The main heating part (10) is arranged near a position to be chamfered. The peripheral heating part (20) is, in a direction perpendicular to the relative movement direction of the glass substrate (1), arranged adjacent to the main heating part (10), and arranged on a side farther from a position where the thermal processing is subjected to the glass substrate (1), than the main heating part (10).

### TECHNICAL FIELD

The present invention relates to a heating device for heating a brittle material substrate to be thermally processed.

### BACKGROUND ART

A device in which thermal processing such as chamfering is subjected to a brittle material substrate such as a glass substrate, etc. has been conventionally known. Patent Document 1 discloses this kind of chamfering device. The chamfering device of Patent Document 1 is configured that, laser beam is irradiated to an end surface of a glass substrate while moving the glass substrate and a laser beam irradiation device relative to each other and thereby the end surface of the glass substrate is chamfered.

In the chamfering device of Patent Document 1, in order to solve a problem that strong tensile stress remains around edges of the glass substrate (residual tensile stress is generated) when cooling the glass substrate after chamfering, a predetermined portion of a surface of the glass substrate is heated so as to have maximum temperature of the glass substrate. Accordingly, stress is generated on the end surface of the glass substrate due to reaction of thermal expansion of the predetermined portion. Under such generation of the stress, the end surface of the glass substrate is chamfered, which can reduce the residual tensile stress around the edges of the glass substrate after the glass substrate is cooled.

### PRIOR-ART DOCUMENTS

### Patent Documents

PATENT DOCUMENT 1: Japanese Patent Application Laid-Open No. 2009-35433

### SUMMARY OF THE INVENTION

### Problems to be Solved by the Invention

However, in a configuration of Patent Document 1, a temperature difference between the predetermined portion that is heated at maximum temperature and its peripheral portion in the glass substrate is extremely large. Therefore, residual tensile stress is generated at a boundary between a heated portion (predetermined portion) and an unheated portion after the glass substrate is cooled, which may cause cracking and chipping of the glass substrate.

The present invention has been made in view of the circumstances described above, and a potential object of the present invention is to reduce generation of residual tensile stress in a brittle material substrate to be thermally processed, and to reduce occurrence of cracking, chipping and the like in the glass substrate.

### Means for Solving the Problems

Problems to be solved by the present invention are as described above, and next, means for solving the problems and effects thereof will be described.

According to an aspect of the present invention, a heating device with the following configuration is provided. That is, the heating device partially heats a brittle material substrate to be thermally processed along with relative movement of the brittle material substrate. The heating device includes a first heating part and a second heating part. The first heating part heats the brittle material substrate up to a temperature near a softening point of such brittle material. The second heating part heats the brittle material substrate up to a temperature equal to or lower than a strain point of the brittle material. The first heating part is arranged near a position where thermal processing is subjected. The second heating part is, in a direction perpendicular to a relative movement direction of the brittle material substrate, arranged adjacent to the first heating part, and arranged on a side farther from a position where the brittle material substrate is thermally processed, than the first heating part.

Accordingly, since the brittle material substrate is heated to low temperature stepwisely as separating from the position where thermal processing is subjected, a temperature difference between the heated portion and the unheated portion is small. Even when the brittle material substrate is cooled after thermal processing, residual tensile stress is less likely to be generated in a boundary between the heated portion and the unheated portion. This can reduce cracking and chipping on the brittle material substrate.

### Effects of the Invention

In one aspect of the present invention, residual tensile stress is less likely to be generated in a brittle material substrate to be thermally processed, which can reduce cracking, chipping and the like on a glass substrate.

### BRIEF DESCRIPTION OF THE DRAWINGS

FIG. 1 A plan view schematically showing a heating device according to an embodiment of the present invention, and a glass substrate to be chamfered while being heated by the heating device.

FIG. 2 A front view schematically showing the heating device and the glass substrate.

FIG. 3 A side view schematically showing the heating device and the glass substrate.

FIG. 4 A front view schematically showing a configuration of a main heating part and a peripheral heating part.

FIG. 5 A graph showing a temperature change along with relative movement of a brittle material substrate at positions A, B, C and D on the brittle material substrate shown in FIG. 1.

### EMBODIMENT FOR CARRYING OUT THE INVENTION

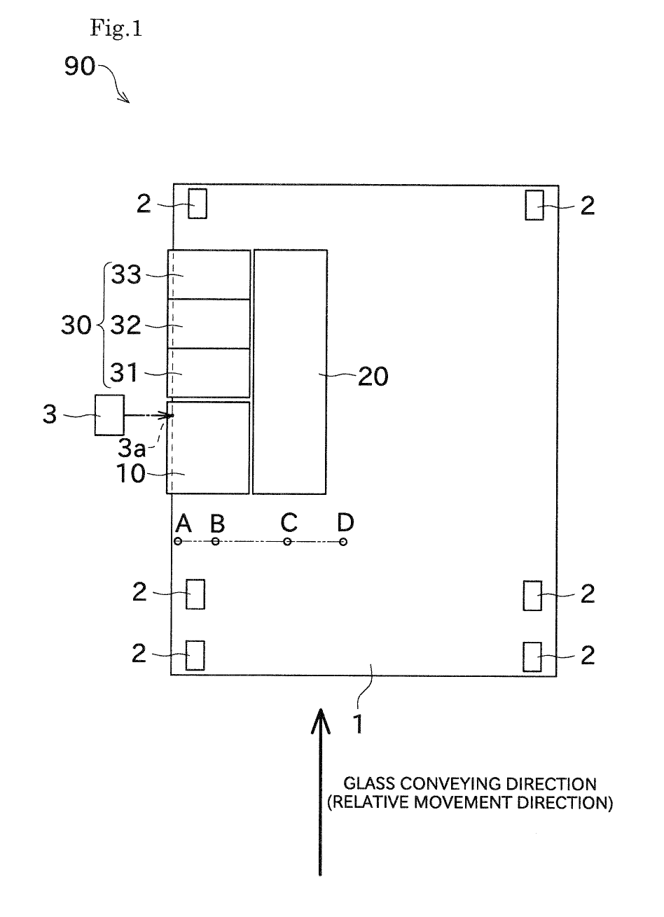

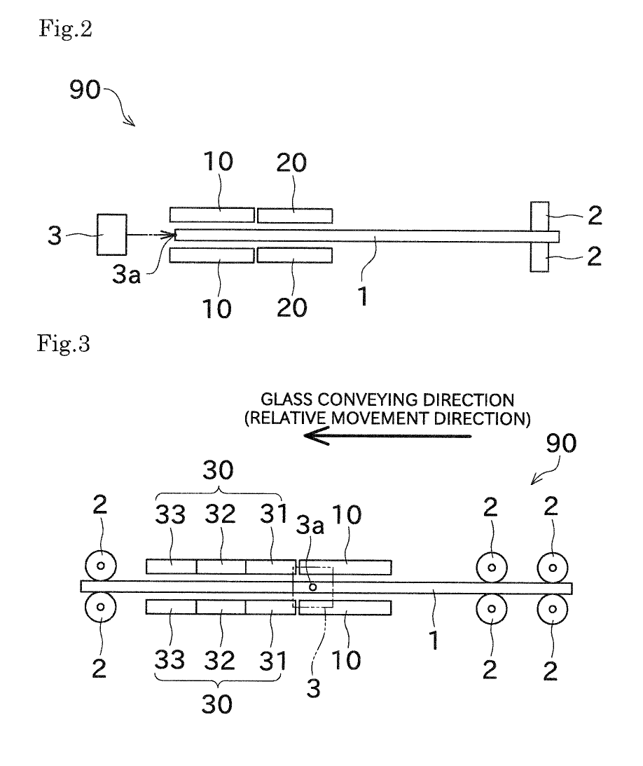

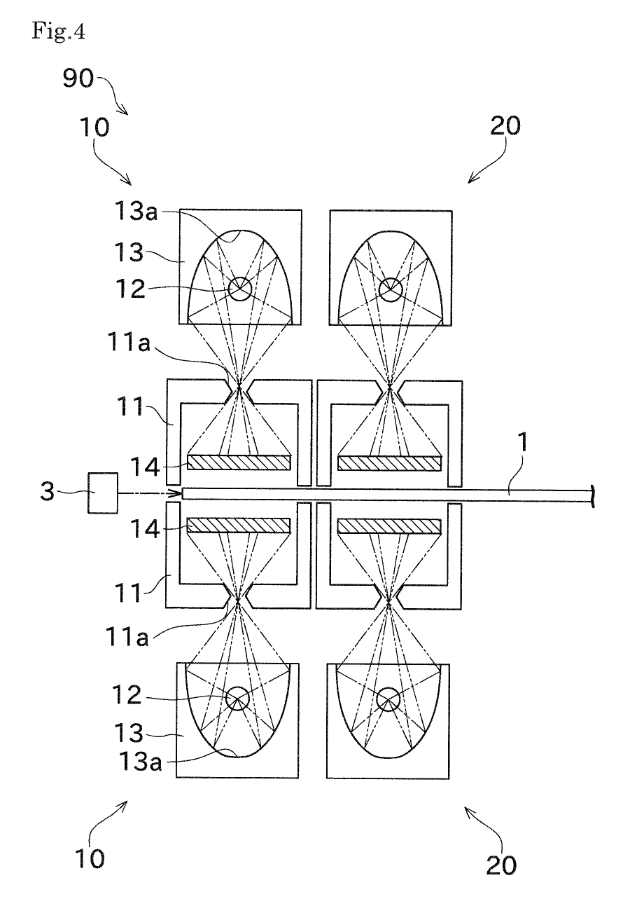

Next, an embodiment of the present invention will be described with reference to drawings. FIG. 1 is a plan view schematically showing a heating device 90 according to one embodiment of the present invention, and a glass substrate 1 to be chamfered while being heated by the heating device 90. FIG. 2 is a front view schematically showing the heating device 90 and the glass substrate 1. FIG. 3 is a side view schematically showing the heating device 90 and the glass substrate 1.

When an edge of the glass substrate (glass plate) 1 as an example of a brittle material substrate is chamfered by using a heating and melting method with a laser irradiation device (a light irradiation device for thermal processing) 3, the heating device 90 of this embodiment heats such processed portion and its peripheral portion.

The glass substrate 1 is formed as a rectangular plate having a certain thickness. The glass substrate 1 is supported, in a horizontal state, while being sandwiched between conveyance rollers (guide members) 2 arranged in pairs. The thickness and the like of the glass substrate 1 is exaggeratedly shown in FIG. 2 and FIG. 3, etc. The conveyance rollers 2 are connected to an electric motor (not shown) as a driving source. The conveyance rollers 2 are driven by the electric motor, which can horizontally convey the glass substrate 1.

The laser irradiation device (thermal processing device) 3 for which the edge of the glass substrate 1 is melted and chamfered is arranged in the middle of a path through which the glass substrate 1 is conveyed. The glass substrate 1 is conveyed by the conveyance rollers 2 while being positioned so that an end surface of the glass substrate 1 is located at a laser beam irradiation position (hereinafter referred to as a “chamfering position”) of the laser irradiation device 3. The glass substrate 1 is conveyed, and thereby, in the glass substrate 1, the end surface of the edge facing the laser irradiation device 3 sequentially passes through a chamfering position 3a from one end to the other end in a conveying direction (a state in the middle of chamfering is shown in FIG. 1 to FIG. 3). At the chamfering position 3a, laser beam is irradiated on the end surface of the glass substrate 1, and thereby the end surface of the glass substrate 1 is heated to high temperature (for example, 1000° C.) and melted. This can achieve chamfering.

A heating device 90 of this embodiment is arranged near the laser irradiation device 3. The heating device 90 can heat the glass substrate 1 before or after the laser beam is irradiated on the end surface of the glass substrate 1.

In this embodiment, the glass substrate 1 is chamfered and heated while moving the glass substrate 1 relative to the laser irradiation device 3 and the heating device 90. Therefore, the glass substrate 1 relatively moves to the laser irradiation device 3 and the heating device 90. Hereinafter, a direction in which the glass substrate 1 relatively moves to the laser irradiation device 3 and the heating device 90 (the direction indicated by a bold arrow in FIG. 1 and FIG. 3) may be referred to as a “relative movement direction”. Regarding an area where the heating device 90 heats the glass substrate 1, an end positioned on an upstream side in the relative movement direction may be referred to as a “start end”, and an end positioned on a downstream side in the relative movement direction may be referred to as a “terminal end”.

The conveyance rollers 2 movably support the glass substrate 1 at a position apart from both the position where the glass substrate 1 is chamfered and the position where the glass substrate 1 is heated. That is, the conveyance rollers 2 support a relatively low temperature portion of the glass substrate 1. Accordingly, the glass substrate 1 can be positioned and conveyed while preventing thermal deformation due to contact with the conveyance rollers 2.

The heating device 90 is a device for partially heating the glass substrate 1 along with relative movement of the glass substrate 1. The heating device 90 of this embodiment is arranged so as to face the glass substrate 1 on both sides in the thickness direction. The heating device 90 includes a main heating part (first heating part) 10, a peripheral heating part (second heating part) 20, and an annealing part (third heating part) 30, other than the above-described conveyance rollers 2.

The heating device 90 of this embodiment is arranged close to a conveyance path of the glass substrate 1 so as to sequentially heat portions near the chamfering position 3a of the glass substrate 1.

The main heating part 10 shown in FIG. 1 to FIG. 3 is arranged near the above-described chamfering position 3a, and partially heats the glass substrate 1. The main heating part 10 heats the glass substrate 1 to a temperature slightly lower than a softening point of the glass (for example, 800° C.).

As shown in FIG. 1, as seen in the thickness direction of the glass substrate 1, on a predetermined rectangular region (hereinafter may be referred to as a “main heating region”) in the heating device 90, the main heating part 10 heats a portion facing such region of the glass substrate 1. The main heating region has a certain width in the direction perpendicular to the relative movement direction of the glass substrate 1. The main heating region includes a portion positioned on an upstream side from the chamfering position 3a, in the relative movement direction of the glass substrate 1. Accordingly, the edges of the glass substrate 1 and its peripheral portion are preheated prior to chamfering. This can reduce a temperature rise range due to chamfering by the laser irradiation device 3, and can prevent a large temperature difference between the chamfered portion and its vicinity. A detailed configuration of the main heating part 10 will be described later.

The peripheral heating part 20 shown in FIG. 1 and FIG. 2 partially heats the glass substrate 1. The peripheral heating part 20 is, in a direction perpendicular to the relative movement direction of the glass substrate 1, arranged adjacent to the main heating part 10, and arranged on a side farther than the main heating part 10 as seen from the chamfering position 3a. Therefore, a rectangular region where the peripheral heating part 20 heats the glass substrate 1 (hereinafter may be referred to as a “peripheral heating region”) is adjacent to the above-described main heating region. A start end of the main heating region and a start end of the peripheral heating region are almost identical in the relative movement direction of the glass substrate 1. Furthermore, the peripheral heating region is arranged so as to correspond to a region combining the main heating region and an annealing region which will be described later, in a direction perpendicular to the relative movement direction of the glass substrate 1. The peripheral heating part 20 heats the glass substrate 1 facing the peripheral heating region to a temperature equal to or lower than the strain point of the glass and close to the strain point (for example, 550° C.).

Accordingly, the glass substrate 1 has a portion where the peripheral heating part 20 heats to medium temperature, between a portion where the main heating part 10 heats to high temperature and an unheated portion. That is, the glass substrate 1 is heated to low temperature stepwisely as the glass substrate 1 separates from the chamfering position 3a. Therefore, in the glass substrate 1, positional temperature gradient between the heated portion and the unheated portion becomes gentle. Even when the glass substrate 1 is cooled after chamfering, residual tensile stress hardly generates at the boundary between the heated portion and the unheated portion.

The annealing part 30 shown in FIG. 1 and FIG. 3 is a part for heating in order to have gentle temperature drop of the glass substrate 1 after heating by the main heating part 10 (in other words, chamfering by the laser irradiation device 3). The annealing part 30 is arranged adjacent to the main heating part 10, and arranged downstream of the main heating part 10 in the relative movement direction of the glass substrate 1. Therefore, the rectangular region heated by the annealing part 30 for annealing (hereinafter may be referred to as an “annealing region”) is adjacent to the above-described main heating region, in a downstream side of the relative movement direction of the glass substrate 1. The annealing region has the same width as the main heating region in the direction perpendicular to the relative movement direction of the glass substrate 1. The annealing part 30 is also arranged adjacent to the peripheral heating part 20.

The annealing part 30 anneals a portion of the glass substrate 1 heated by the main heating part 10, to a temperature equal to or lower than the strain point of the glass. It is preferable that a terminal end of the region (annealing region) heated by the annealing part 30 substantially coincides with the terminal end of the region (peripheral heating region) heated by the peripheral heating part 20, in the relative movement direction of the glass substrate 1. In the glass substrate 1, the temperature of the portion passing through the terminal end on the annealing region is preferably a temperature equal to or higher than the temperature of the portion passing through the terminal end of the peripheral heating region, as well as the temperature in the vicinity thereof. Accordingly, in the glass substrate 1, the temperature difference between the portion passing through the main heating region and the annealing region, and the portion passing through the peripheral heating region becomes small, which can suppress generation of residual tensile stress at the boundary.

The annealing part 30 of this embodiment includes a high temperature heater 31 arranged on the most upstream side in the relative movement direction of the glass substrate 1, a medium temperature heater 32 arranged adjacent to the high temperature heater 31 and arranged downstream of the high temperature heater 31, and a low temperature heater 33 arranged adjacent to the medium temperature heater 32 and arranged downstream of the medium temperature heater 32.

The high temperature heater 31 heats the portion of the glass substrate 1 heated by the main heating part 10, to a temperature slightly lower than the softening point of the glass (for example, 800° C. which is the same as the temperature in the main heating part 10). The high temperature heater 31 has a certain width in both the relative movement direction of the glass substrate 1 and the direction perpendicular thereto. Therefore, the temperature of the edge of the glass substrate 1 to be chamfered locally rises to 1000° C. by laser irradiation with the laser irradiation device 3. In the process of passing through the region heated by the high temperature heater 31, the temperature drops to 800° C., which is almost the same as the peripheral portion, and the temperature difference can be almost eliminated.

The medium temperature heater 32 anneals a portion of the glass substrate 1 heated by the high temperature heater 31, to medium temperature between the softening point and the strain point of the glass (for example, 700° C.).

The low temperature heater 33 anneals a portion of the glass substrate 1 heated by the medium temperature heater 32, to the temperature slightly lower than the strain point of the glass (for example, 550° C.).

In this configuration, a portion of the glass substrate 1 passing through the main heating region subsequently passes through the annealing region (in other words, subsequently passes through each region heated by the high temperature heater 31, the medium temperature heater 32, and the low temperature heater 33), and thereby such portion is cooled to the temperature lower than the strain point with a temporally gradual temperature gradient. This can cool the glass substrate 1 with little strain, and prevent cracking and chipping of the glass substrate 1.

The annealing part 30 of this embodiment includes heaters with three temperature stages, the high temperature heater 31, the medium temperature heater 32, and the low temperature heater 33, but not limited thereto. That is, the annealing part 30 may include a heater with the temperature stages more subdivided than the above-described heaters, or may include the heater with the temperature stages rougher than the above-described heaters (for example, two stages of medium temperature and low temperature). The annealing part 30 may include a further simplified heater with the one temperature stage.

As shown in FIG. 2 and FIG. 3, each of the above-described main heating part 10, the peripheral heating part 20, and the annealing part 30 is configured to heat the glass substrate 1 from both sides in the thickness direction. Therefore, the temperature gradient of the glass substrate 1 in the thickness direction can be small, and cracking and chipping, etc. can be reduced in the glass substrate 1.

In the following, a specific configuration of the main heating part 10 will be described with reference to FIG. 4. FIG. 4 is a front view schematically showing each configuration of the main heating part 10 and the peripheral heating part 20. A two-dot chain line in the drawing schematically shows light beam.

The main heating part 10 shown in FIG. 4 has a pair of heat-insulating casings (heat insulators) 11, a pair of halogen lamps (heat sources) 12, a pair of concave mirrors 13, and a pair of metal members 14. The heat-insulating casings 11, the halogen lamps 12, the concave mirrors 13, and the metal members 14 are arranged so as to be symmetrical with respect to the glass substrate 1.

Each heat-insulating casing 11 is arranged so as to cover one side of the thickness direction of the glass substrate 1. Each heat-insulating casing 11 made of the known heat insulator has a box shape whose side close to the glass substrate 1 is opened. Each heat-insulating casing 11 is arranged so as to surround the above-described main heating region. As a result, a heat-insulating space is formed within each heat-insulating casing 11. A slit-like light passage 11a for passing light beam from each halogen lamp 12 is formed through a wall portion of each heat-insulating casing 11 far from the glass substrate 1. As such, the main heating part 10 heats a portion of the glass substrate 1 to be heated, which is covered with each heat-insulating casing 11. Therefore, heat cannot be easily released, and the glass substrate 1 can be efficiently heated.

Due to power supply, each halogen lamp 12 irradiates light beam for heating the glass substrate 1. As such, since the halogen lamp 12 is arranged outside each heat-insulating casing 11, maintenance of each halogen lamp 12 is facilitated.

Each concave mirror 13 is configured to cover each halogen lamp 12, and has a reflecting surface 13a with a curved cross-sectional shape. The reflecting surface 13a is configured to reflect light beam irradiated by each halogen lamp 12 and guide the reflected light to the inside of each heat-insulating casing 11 while forming a focal point inside or near the light passage 11a. Accordingly, the light beam of each halogen lamp 12 is concentrated inside each heat-insulating casing 11, which can efficiently heat the glass substrate 1. The focal point is formed inside or near the light passage 11a, and thereby the size of an opening which is formed in the heat-insulating casing 11 in order to form the light passage 11a. This can suppress deterioration of a heat-insulating effect.

Each metal member 14 is arranged inside the heat-insulating casing 11. More specifically, each metal member 14 is arranged between the light passage 11a and the glass substrate 1. The metal member 14 having a plate shape is made of a heat resistant material such as stainless steel, Hastelloy, Inconel, or the like. In such configuration, the light beam from each halogen lamp 12 passes through the light passage 11a, and such light beam is irradiated to each metal member 14. The radiant heat from each metal member 14 whose temperature is raised is thus irradiated to the glass substrate 1. As such, the radiant heat from each metal member 14 is utilized to heat, which can sufficiently heat the glass substrate 1 even when using a heat source (for example, the halogen lamp 12 of this embodiment) for irradiating the light beam with low absorptivity to the glass. As described above, in the heating device 90 of this embodiment, since a reasonable halogen lamp or the like can be used as a heat source, manufacturing cost can be reduced.

The peripheral heating part 20 has the same configuration as the main heating part 10, as shown in FIG. 4. In this embodiment, each of the high temperature heater 31, the medium temperature heater 32, and the low temperature heater 33 which are included in the annealing part 30 has the same configuration as the main heating part 10, not shown in the drawings. The heating temperature of each heating part can be appropriately adjusted by adjusting the amount of electric power to be supplied to each halogen lamp 12 or adjusting the distance from each halogen lamp 12 to a portion of the glass substrate 1 to be heated.

However, it is not necessary that all of the main heating part 10, the peripheral heating part 20, and the annealing part 30 include halogen heaters. A part or all of the main heating part 10, the peripheral heating part 20, and the annealing part 30 may be replaced by heaters with different configuration (for example, a sheathed heater).

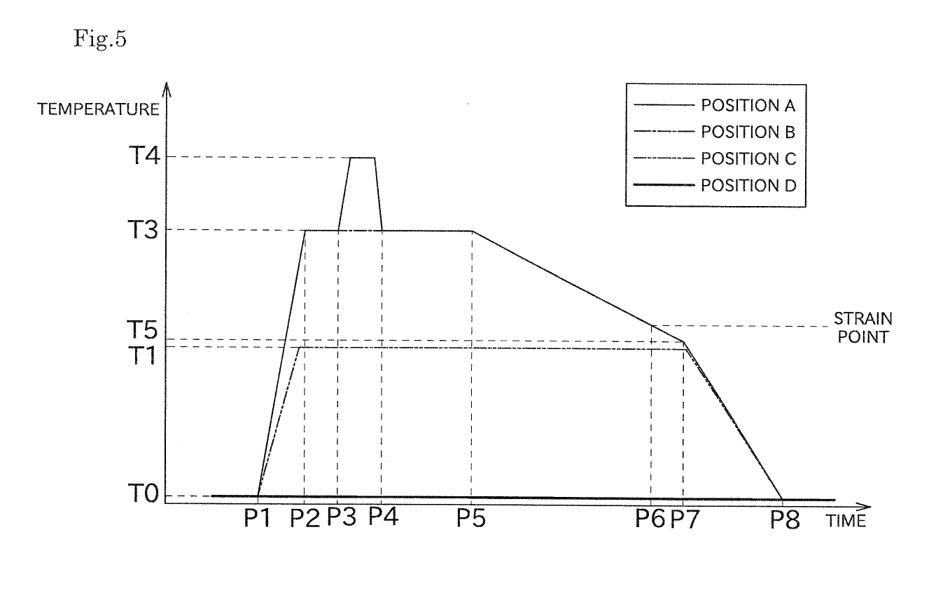

In the following, the temperature change of the glass substrate 1 will be specifically described. FIG. 5 shows the temperature change due to relative movement of the glass substrate 1 in the positions (portions) A, B, C, and D that are set on one side surface in the thickness direction of the glass substrate 1, shown in FIG. 1. Each temperature change at a position A and a position B in a graph of FIG. 5 is identical to each other, except for a time interval from P3 to P4.

As shown in FIG. 1, the position A is set at a position passing right near the chamfering position 3a. Although the position B is not as close to the chamfering position 3a as the position A, the position B is set at a position passing through the main heating region and the annealing region. The position C is set at a position passing through the peripheral heating region. The position D is set at a position farther from the chamfering position 3a than the peripheral heating region, in a direction perpendicular to the relative movement direction of the glass substrate 1 (therefore, the position D does not pass through any of the main heating region, the annealing region, and the peripheral heating region.). The positions A, B, C, and D are linearly arranged in a direction perpendicular to the relative movement direction of the glass substrate 1.

At a point before the glass substrate 1 is conveyed to the laser irradiation device 3 and the heating device 90, all of the positions A, B, C and D have the temperature (T0) near room temperature. The positions A and B pass through the main heating region during the time interval from P1 to P2, and thereby each temperature at the positions A and B rises to the temperature near the softening point (for example, 800° C., T3). The positions A and B are heated to the temperature above the strain point, and thereby their stress is released. A slope (temporal temperature gradient) in which the temperature rises during the time interval from P1 to P2 is appropriately set so that cracking or the like does not occur in the glass. If necessary, the main heating part 10 may be divided into a low temperature section, a medium temperature section, and a high temperature section, so that the rapid temperature rise can be mitigated.

The position C enters the peripheral heating region at the point P1. As a result, the temperature at the position C rises to the temperature equal to or lower than the strain point, near the strain point (for example, 550° C., T1). Due to such temperature rise, the glass substrate 1 at the position C is elastically deformed, and the stress is generated at high temperature.

After the temperature in a region close to the edge of the glass substrate 1 (a region including the positions A and B) is sufficiently raised, in the time interval P3 to P4, the laser beam is irradiated by the laser irradiation device 3 and then chamfering is subjected. In this case, although the temperature at the position A becomes locally high near the softening point (for example, 900° C.), the stress is not generated because the position A is in a viscous flow state.

During the time interval P4 to P5, the positions A and B pass through in the annealing region heated by the high temperature heater 31. Accordingly, locally high temperature at the position A becomes the temperature T3 which is a setting temperature of the high temperature heater 31 or the temperature near T3 (for example, 800° C.). The temperature at the position B is kept substantially at T3. As a result, there is almost no temperature difference between the position A and the position B.

During the time interval P5 to P7, the positions A and B subsequently pass through the annealing region heated by the medium temperature heater 32, and the annealing region heated by the low temperature heater 33. Accordingly, each temperature in the positions A and B is lowered to the temperature equal to or lower than the strain point (for example, 550° C., T5) with gentle gradient. In such annealing process, the temporal temperature gradient especially when passing over the strain point of the glass (especially, the temperature gradient until the temperature changes from the annealing point of the glass to the strain point) is small, which can properly prevent generation of strain. The positions A and B are in the viscous flow state until the point P6 where the temperature passes over the strain point. Therefore, the stress is not generated even if the temperature is lowered. When the temperature reaches the point after the point P6 where the temperature passes over the strain point, elastic deformation is started at the positions A and B and the stress is generated.

At the point P6, the temperature difference between a portion in the glass substrate 1 heated by the low temperature heater 33 and a portion in the glass substrate 1 heated by the peripheral heating part 20 is (strain point−T1) ° C. Such temperature difference causes the residual tensile stress after the glass substrate 1 is cooled to room temperature. Therefore, it is preferable to minimize the temperature difference (strain point−T1).

The temperature at the position C is kept at T1 until the point P7 by continuing heating from the point P1.

The positions A, B, and C have the substantially same temperature (T1) at the point P7. Therefore, during the time interval P7 to P8, each temperature at the positions A, B and C is in a uniform state and cooled to T0. No residual tensile stress is generated at the boundary of the target region to be heated in each heater. After passing through the point P7 where the temperature reaches T1, cooling may be positively performed by using cooling air or the like within a range where no cracking or the like occurs in the glass.

The temperature at the position C rises from T0 (ambient temperature/room temperature) to T1, and then drops to T0. Since T1 is a temperature equal to or lower than the strain point (for example, 550° C.), the glass substrate 1 at the position C is merely elastically deformed. Therefore, when the temperature returns to T0, the residual tensile stress is not generated in the region including the position C.

The glass substrate 1 is heated by the heating device 90, which causes the above-described temperature change. Therefore, even when the glass substrate 1 is cooled after chamfering, the residual tensile stress is not easily generated, and cracking, chipping and the like are not easily occurred in the glass substrate 1.

As such, in this embodiment, before or after the glass substrate 1 is thermally processed (chamfered), the glass substrate 1 is partly heated by the heating device 90. This can suppress generation of the residual tensile stress which is a conventional problem when performing thermal processing using a laser. This can also perform laser thermal processing on the glass substrate 1 while preventing cracking and chipping in the glass substrate 1. Since chamfering is performed by the heating and melting method, there is no occurrence of glass cullet due to processing, and also there is no need to perform a powerful cleaning step for removing the glass cullet after processing. This can reduce the number of steps and an environmental burden.

Heating by the heating device 90 is unnecessary for the entire glass substrate 1. It is sufficient to heat a part of the glass substrate 1. Therefore, it is unnecessary to prepare a large heating furnace or the like which stores the entire glass substrate 1, and thereby the equipment cost can be reduced. Furthermore, a reasonable halogen heater or the like can be used for partially heating by the heating device 90, and the cost can be reduced in this respect.

As described above, the heating device 90 of this embodiment partially heats the glass substrate 1 to be chamfered along with relative movement of the glass substrate 1. The heating device 90 includes the main heating part 10 and the peripheral heating part 20. The main heating part 10 heats the glass substrate 1 to the temperature near the softening point of the glass. The peripheral heating part 20 heats the glass substrate 1 to the temperature equal to or lower than the strain point of the glass. The main heating part 10 is arranged near the chamfering position 3a. The peripheral heating part 20 is, in a direction perpendicular to the relative movement direction of the glass substrate 1, arranged adjacent to the main heating part 10 and arranged on a side farther from the chamfering position 3a, than the main heating part 10.

Accordingly, as seen from the direction perpendicular to the relative movement direction of the glass substrate 1, the glass substrate 1 is heated to low temperature stepwisely as separating from the chamfering position 3a. Therefore, the temperature difference between the heated portion and the unheated portion is small. Accordingly, even when the glass substrate 1 is cooled after chamfering, the residual tensile stress hardly generates at the boundary between the heated portion and the unheated portion. This can reduce occurrence of cracking and chipping in the glass substrate 1.

The heating device 90 of this embodiment includes the annealing part 30 that is arranged adjacent to the main heating part 10, and arranged downstream of the main heating part 10 in the relative movement direction of the glass substrate 1. The annealing part 30 anneals a portion in the glass substrate 1 heated by the main heating part 10, to the temperature equal to or lower than the strain point of the glass.

Accordingly, the temperature gradient when the glass substrate 1 is cooled after chamfering (especially, when passing over the strain point) becomes gentle. The residual tensile stress hardly generates near the position where chamfering is subjected. This can reduce cracking and chipping on the glass substrate 1.

In the heating device 90 of this embodiment, the annealing part 30 is arranged adjacent to the peripheral heating part 20. When the glass substrate 1 is annealed by the annealing part 30 and thereby its temperature reaches the strain point, such temperature (each temperature at the positions A and B in the point P6) is equal to or higher than and near the temperature (the temperature at the position C in the point P6) which is reached by heating the glass substrate 1 by the peripheral heating part 20.

Accordingly, in the glass substrate 1, the temperature difference between the portion heated by the annealing part 30 and the portion heated by the peripheral heating part 20 becomes small. Therefore, the residual tensile stress at the boundary is hardly generated. In the glass substrate 1, although the temperature difference between the portion heated by the peripheral heating part 20 and its peripheral unheated portion is caused, the temperature heated by the peripheral heating part 20 is equal to or lower than the strain point. Therefore, the residual tensile stress is not generated even after cooling.

In the heating device 90 of this embodiment, the main heating part 10 can heat the upstream side of the chamfering position 3a, in the relative movement direction of the glass substrate 1.

Accordingly, since the portion to be chamfered in the glass substrate 1 is preheated, a temperature rise range due to chamfering can be reduced and cracking and chipping in the glass substrate 1 can be prevented.

The heating device 90 of this embodiment has the conveyance rollers 2 for movably supporting the glass substrate 1 at a position apart from both the position where the glass substrate 1 is chamfered and the position where the glass substrate 1 is heated.

Accordingly, the glass substrate 1 can be positioned while preventing thermal deformation of the glass substrate 1.

In the heating device 90 of this embodiment, each of the main heating part 10 and the peripheral heating part 20 heats the glass substrate 1 from both sides in the thickness direction.

Accordingly, the temperature gradient of the glass substrate 1 in the thickness direction can be reduced, which can further prevent cracking and chipping in the glass substrate 1.

In the heating device 90 of this embodiment, each of the main heating part 10 and the peripheral heating part 20 heats the glass substrate 1 that is covered with a heat insulator.

Accordingly, heat cannot be easily released, and a portion to be heated in the glass substrate 1 can be efficiently heated.

In the heating device 90 of this embodiment, each of the main heating part 10 and the peripheral heating part 20 has the halogen lamp 12 that is arranged outside the heat-insulating casing 11. The heat-insulating casing 11 has the light passage 11a for passing the light beam from each halogen lamp 12. The light beam from the halogen lamp 12 forms the focal point within or near the light passage 11a.

Accordingly, the halogen lamp 12 is arranged outside the heat-insulating casing 11, which can facilitate maintenance of the halogen lamp 12. Since the light passage 11a can be formed small, heat cannot be easily released outside the heat-insulating casing 11. Therefore, heating can be efficiently performed.

In the heating device 90 of this embodiment, each of the main heating part 10 and the peripheral heating part 20 has the metal member 14 that is arranged between the light passage 11a and a portion to be heated in the glass substrate 1.

Accordingly, in the main heating part 10 and the peripheral heating part 20, the portion to be heated in the glass substrate 1 can be effectively heated by the radiant heat from the metal member 14. Therefore, even in using a heat source (for example, the halogen heater) which emits the light beam with low absorptivity to the glass, the portion to be heated in the glass substrate 1 can be sufficiently heated.

While a preferred embodiment of the present invention has been described above, the above-described configuration can be modified, for example, as follows.

In the above-described embodiment, the brittle material substrate is the glass substrate, but not limited thereto. For example, a sapphire substrate or a ceramic substrate may be used instead. That is, the present invention can be widely applied to heating of a substrate made of the brittle material (material with small strain until break).

In the above-described embodiment, the heating device 90 is configured to heat the glass substrate 1 when the glass substrate 1 is chamfered by heat. However, instead of this, the heating device 90 can be used as a heating device for heating a peripheral portion of the glass substrate 1 when the glass substrate 1 is cutting-processed, for example, by heat. That is, “thermal processing” of the present invention includes any thermal processing for processing by applying heat to a part of the brittle material substrate. The thermal processing may be subjected to a portion other than the end portion as seen the brittle material substrate in the thickness direction.

A direction where the laser irradiation device 3 irradiates the laser beam to the chamfering position 3a is, as shown in FIG. 2, not limited to the direction perpendicular to the thickness direction of the glass substrate 1. The direction may be properly inclined. The irradiation direction of the laser beam is, as shown in FIG. 1, not limited to the direction perpendicular to the relative movement direction of the glass substrate 1. The direction may be properly inclined.

In the above-described embodiment, thermal processing is subjected by the laser irradiation device 3, but this is not limited thereto. For example, instead of the laser beam, the thermal processing such as chamfering may be subjected to the glass substrate 1 by using the halogen heater or the sheathed heater. When the thermal processing is subjected by irradiating the light beam from the halogen heater, for example, each configuration of the heat-insulating casing 11, the concave mirror 13, the metal member 14, etc. shown in FIG. 4, are applied. Accordingly, even when the light source (for example, the halogen lamp) which irradiates the light beam with low absorptivity to the brittle material is used, the glass substrate 1 can be heated to the temperature required for the thermal processing.

In order to effectively heat the glass substrate 1, a reflector, a mirror, or the like for reflecting the light beam may be attached to an inner surface (internal surface) of the heat-insulating casing 11.

The metal member 14 may be omitted, and the light beam from the halogen lamp 12 may be directly irradiated to the glass substrate 1.

In the above-described embodiment, each position of the laser irradiation device 3 and the heating device 90 is fixed, and the glass substrate 1 moves toward these devices, but this is not limited thereto. That is, relative movement of the glass substrate 1 may be achieved by movement of the laser irradiation device 3 and the heating device 90 toward the glass substrate 1 that is fixed to a predetermined position. Both the glass substrate 1, and the laser irradiation device 3 and the heating device 90 may move.

The glass substrate 1 to which the thermal processing and heating are subjected may have a vertical attitude, for example, instead of a horizontal attitude as shown in FIG. 1.

The plurality of peripheral heating parts 20 may be provided in the direction perpendicular to the relative movement direction of the glass substrate 1, and then the glass substrate 1 may be heated while changing the temperature more finely.

The heating device 90 may be configured to collectively heat the plurality of glass substrates 1.

In the above-described embodiment, guide members for movably supporting the glass substrate 1 are the conveyance rollers 2 in pairs, but this is not limited thereto. For example, instead of this, the guide member may have a chuck-like configuration.

The laser irradiation device 3 and the heating device 90 may be provided in pairs respectively. One end of the glass substrate 1 may be chamfered and heated at the same time or before or after the other end of the glass substrate 1 is chamfered and heated.

### DESCRIPTION OF THE REFERENCE NUMERALS

1 glass substrate (brittle material substrate)
10 main heating part (first heating part)
20 peripheral heating part (second heating part)
30 annealing part (third heating part)
90 heating device

1-9. (canceled)

10. A heating device that partially heats a brittle material substrate to be thermally processed along with relative movement of the brittle material substrate, comprising:
a first heating part heating the brittle material substrate to a temperature near a softening point of a brittle material; and
a second heating part heating the brittle material substrate to the temperature equal to or lower than a strain point of the brittle material,
wherein the first heating part is arranged near a position to be thermally processed, and wherein the second heating part is, in a direction perpendicular to a relative movement direction of the brittle material substrate, arranged adjacent to the first heating part, and arranged on a side farther from the position where thermal processing is subjected to the brittle material substrate, than the first heating part.

11. The heating device according to claim 10, further comprising:
a third heating part arranged adjacent to the first heating part and arranged downstream of the first heating part in the relative movement direction of the brittle material substrate,
wherein the third heating part anneals a portion of the brittle material substrate after heating by the first heating part, up to the temperature equal to or lower than the strain point of the brittle material.

12. The heating device according to claim 11, wherein the third heating part is arranged adjacent to the second heating part, in the brittle material substrate, the temperature in a portion where heating in the third heating part is finished is equal to or higher than and near the temperature in the portion where heating in the second heating part is finished.

13. The heating device according to claim 12, wherein the first heating part can heat an upstream side of a position where the thermal processing is subjected to the brittle material substrate, in the relative movement direction of the brittle material substrate.

14. The heating device according to claim 10, further comprising:
a guide member in which the brittle material substrate is movably supported at a position apart from both the position where the thermal processing is subjected to the brittle material substrate and the position where the brittle material substrate is heated.

15. The heating device according to claim 10, wherein each of the first heating part and the second heating part heats the brittle material substrate from both sides in a thickness direction.

16. The heating device according to claim 10, wherein each of the first heating part and the second heating part heats the brittle material substrate that is covered with a heat insulator.

17. The heating device according to claim 16, wherein each of the first heating part and the second heating part has a heat source that is arranged outside the heat insulator, the heat insulator has a light passage for passing light beam from the heat source, and the light beam from the heat source forms a focal point within or near the light passage.

18. The heating device according to claim 17, wherein each of the first heating part and the second heating part has a metal member that is arranged between the light passage and a portion in the brittle material substrate to be heated.
